(19) United States
(12) Patent Application Publication
(10) Pub. No.: US 2026/0041103 A1
(43) Pub. Date: Feb. 12, 2026

(54) INSECT REPELLENT FORMULATIONS, COMPOSITIONS, AND METHODS FOR PEST CONTROL

(71) Applicant: TYRATECH, INC., Morrisville, NC (US)

(72) Inventors: Jason Schmidt, Morrisville, NC (US); Justin Heuser, Morrisville, NC (US)

(21) Appl. No.: 19/274,980

(22) Filed: Jul. 21, 2025

Related U.S. Application Data
(60) Provisional application No. 63/680,368, filed on Aug. 7, 2024.

(51) Int. Cl. A01N 65/22; A01N 25/10; A01N 25/30; A01N 31/02; A01N 35/04; A01P 17/00

(52) U.S. Cl. CPC A01N 65/22; A01N 25/10; A01N 25/30; A01N 31/02; A01N 35/04; A01P 17/00

(57) ABSTRACT

Insect repellent compositions are disclosed. Certain embodiments comprise a blend of active ingredients, surfactants, film-forming agents, stabilizers, application enhancers, solvents, and other supporting moieties, and form substantially clear durable films that repel insects for an extended period.

### CROSS-REFERENCE TO RELATED APPLICATIONS

The present application claims the benefit of co-pending U.S. Provisional Ser. No. 63/680,368, filed Aug. 7, 2024, the entire disclosure of which is hereby incorporated herein by reference.

### FIELD OF THE INVENTION

The present invention relates to insect repellent formulations, and to methods of pest control employing insect repellent formulations.

### BACKGROUND

Urban pests, such as ants and cockroaches, are a significant problem for people primarily due to their ability to spread diseases, contaminate food, cause psychological stress, and cause property damage. These pests are particularly adept at thriving in urban environments, where they find abundant food sources, water, and shelter in homes, commercial buildings, and waste disposal areas.

Among the most common urban pests, ants are known for their strong foraging behavior. Ants can contaminate food and are especially troublesome when they form colonies inside structures. Cockroaches, on the other hand, are notorious for their resilience to treatments and ability to spread bacteria and pathogens. Cockroaches are attracted to food remnants and moisture and typically hide in dark, secluded areas during the day.

Controlling and eradicating these pests involves several strategies. Hygiene and sanitation are crucial; regularly cleaning up food crumbs, sealing food containers, and effectively managing waste can significantly reduce their presence. Physical barriers, such as sealing cracks and crevices in walls, around windows and doors, and using screens on vents and windows, can prevent their entry.

Chemical treatments, including insecticides and baits, are commonly used. Baits are particularly effective against ants as they carry the poison back to their colony, while surface sprays and aerosols can be used to combat cockroaches. However, these chemical treatments often require precautions, especially for use in areas frequented by children and pets.

Efforts to improve insect repellents have been mainly directed toward discovering new compounds that may act as active ingredients of the repellent. To date, however, attention has not been focused on formulations specifically designed to create a long-lasting repellent barrier.

### SUMMARY

This section provides a general summary of the disclosure and is not comprehensive of its full scope or all of its features.

According to one non-limiting aspect of the present disclosure, provided herein is an insect repellent composition comprising, in weight percentages based on total weight of the composition: 0.1 to 0.5% cornmint oil; 0.05 to 0.5% isopropyl myristate; 0.25 to 1.0% triethyl citrate; 0.25 to 1.0% monolaurin; 2.0 to 6.0% hydroxypropyl cellulose; 0.01 to 0.3% citric acid; and isopropanol.

According to another non-limiting aspect of the present disclosure, provided herein is an insect repellent composition comprising, in weight percentages based on total weight of the composition: 0.01 to 0.3% geraniol; 0.05 to 0.5% isopropyl myristate; 0.25 to 1.0% triethyl citrate; 0.25 to 1.0% monolaurin; 2.0 to 6.0% hydroxypropyl cellulose; 0.01 to 0.3% citric acid; and isopropanol.

According to yet another non-limiting aspect of the present disclosure, provided herein is an insect repellent composition comprising, in weight percentages based on total weight of the composition: 4.0 to 7.0% vanillin; 0.05 to 0.5% isopropyl myristate; 0.25 to 1.0% triethyl citrate; 0.25 to 1.0% monolaurin; 2.0 to 6.0% hydroxypropyl cellulose; 0.01 to 0.3% citric acid; and isopropanol.

According to yet a further non-limiting aspect of the present disclosure, provided herein is an insect repellent composition comprising, in weight percentages based on total weight of the composition: 0.1 to 0.5% cornmint oil; 0.01 to 0.3% geraniol; 4.0 to 7.0% vanillin; 0.05 to 0.5% isopropyl myristate; 0.25 to 1.0% triethyl citrate; 0.25 to 1.0% monolaurin; 2.0 to 6.0% hydroxypropyl cellulose; 0.01 to 0.3% citric acid; and isopropanol.

According to one non-limiting aspect of the present disclosure, provided herein is an insect repellent composition comprising, in weight percentages based on total weight of the composition: 0.1 to 0.5% cornmint oil; 0.05 to 0.5% isopropyl myristate; 0.25 to 1.0% triethyl citrate; 0.25 to 1.0% monolaurin; 2.0 to 6.0% hydroxypropyl cellulose; and isopropanol.

According to another non-limiting aspect of the present disclosure, provided herein is an insect repellent composition comprising, in weight percentages based on total weight of the composition: 0.01 to 0.3% geraniol; 0.05 to 0.5% isopropyl myristate; 0.25 to 1.0% triethyl citrate; 0.25 to 1.0% monolaurin; 2.0 to 6.0% hydroxypropyl cellulose; and isopropanol.

According to yet another non-limiting aspect of the present disclosure, provided herein is an insect repellent composition comprising, in weight percentages based on total weight of the composition: 4.0 to 7.0% vanillin; 0.05 to 0.5% isopropyl myristate; 0.25 to 1.0% triethyl citrate; 0.25 to 1.0% monolaurin; 2.0 to 6.0% hydroxypropyl cellulose; and isopropanol.

According to yet a further non-limiting aspect of the present disclosure, provided herein is an insect repellent composition comprising, in weight percentages based on total weight of the composition: 0.1 to 0.5% cornmint oil; 0.01 to 0.3% geraniol; 4.0 to 7.0% vanillin; 0.05 to 0.5% isopropyl myristate; 0.25 to 1.0% triethyl citrate; 0.25 to 1.0% monolaurin; 2.0 to 6.0% hydroxypropyl cellulose; and isopropanol.

Additional aspects according to the present disclosure are directed to methods for controlling pests, the methods comprising applying an insect repellent formulation according to the present disclosure to an area.

The foregoing summary is illustrative only and is not intended to be in any way limiting. In addition to the illustrative examples and features described herein, further aspects, examples, objects, and features of the disclosure will become apparent from the drawings and the following detailed description and claims.

### DESCRIPTION OF CERTAIN EMBODIMENTS OF THE INVENTION

The present disclosure relates to insect repellent compositions. In certain embodiments, the insect repellent compositions may be repellent blends comprising one or more active ingredients, surfactants, film-forming agents, stabilizers, application enhancers, solvents, and other supporting moieties. The insect repellent formulations form a substantially clear durable film that repels insects for an extended period (e.g., up to 90 days). The formulations may include ingredients deemed “minimal risk pesticides” by the EPA (“25b/4a”; FIFRA-exempt), making the formulations ideal for use in various environments including sensitive areas where conventional insecticides are not permitted or desired.

The insect repellent compositions may be applied using standard spray equipment by professional pest control operators and/or homeowners and/or maintenance personnel for any structures or properties where such technology is needed.

The purpose and benefits of the insect repellent compositions include, for example, preventing the entry of urban pest insects into structures or living spaces by creating a long-lasting repellent barrier which prevents entry of the insects into treated areas, prevents colonization of a structure, and pushes insects out of the treated area, increasing their exposure to chemical insecticides applied to the outside of the structure.

The advantages of the insect repellent compositions disclosed herein over existing solutions which include traditional insecticides include longer-lasting repellency, environmental friendliness, and safety to the applicator, residents/inhabitants, and animals.

Further, the insect repellent compositions disclosed herein can be used in sensitive areas (i.e., hospitals, schools, restaurant kitchens, etc.), are non-damaging to surfaces, are easy to clean, and offer versatile application methods.

A barrier insect repellent composition, as disclosed herein, can play an important role in integrated pest management (IPM) practices by driving insects from the interior of the dwelling to the outside and into contact with long residual insecticides applied by a professional or homeowner.

Additionally, professional pest control operators will have fewer call back customers requiring them to spend additional resources to consult with the customer and provide additional services without charge.

No commercial products are currently available which provide repellency against urban pest insects, such as cockroaches and ants.

An ant and cockroach repellents, such as the insect repellent compositions disclosed herein, can be a valuable component of an Integrated Pest Management (IPM) program, which emphasizes a holistic approach to pest control, focusing on long-term prevention and minimal risk to humans and the environment. Below is a summary of how such a repellent could be integrated into an IPM strategy:

Preventive Measures: IPM stresses the importance of preventive measures to reduce the attractiveness of the environment to pests. This includes maintaining cleanliness, removing food sources, and sealing entry points. The repellent can be used as a barrier in potential entry points to deter pests from entering.

Targeted Application: Instead of widespread pesticide use, IPM advocates for targeted application where needed. The repellent can be applied in specific areas where ant and cockroach activity is high, reducing the need for more aggressive chemical treatments. Additionally, a repellent could compliment/enhance the efficacy of an outdoor parameter treatment by forcing the pest insects into areas where traditional insecticides are applied.

Reduced Risk Pesticides: In an IPM program, when chemical intervention is necessary, the preference is for products that pose the least risk to human health and the environment. A repellent, especially one made from natural or low-toxicity ingredients, aligns well with this principle. If the repellent is effective in deterring pests, it can reduce the need for further chemical interventions.

Complementary Strategies: The repellent should be used in conjunction with other IPM strategies, such as biological control (using natural predators or parasites of the pests), cultural controls (modifying the environment to make it less conducive to pests), and mechanical controls (like traps).

By incorporating insect repellent compositions, as disclosed herein, into an IPM program, pest control can be achieved in a more economic, sustainable, effective, and environmentally friendly way. This approach minimizes the reliance on chemical pesticides and focuses on long-term prevention and control strategies.

Unless otherwise noted, terms herein are to be understood according to conventional usage by those of ordinary skill in the relevant art.

As used herein, “concentrate” shall refer to any insect repellent formulation that is intended to be mixed with water, for example, in a ratio of 2:1 to 100:1 of formulation to water, to provide an emulsion or suspension of an insect repellent for application.

As used herein, “pests” can mean any organism whose existence it can be desirable to control. Pests can include, for example, insects, nematodes, parasites, and the like. “Pesticidal” can mean, for example, antiparasitic, insecticidal, and the like.

As used herein, the term “pest control” shall refer to having a repellent effect, a pesticidal effect, or both. “Repellent effect” is an effect wherein more pests are repelled away from a host or area that has been treated with the composition than a control host or area that has not been treated with the composition. “Pesticidal effect” is an effect wherein treatment with a composition causes at least about 1% of the pests to die.

As used herein, the term “RTU” means ready-to-use.

As used herein, “component of a composition” refers to a compound, or a subset of compounds, included in a composition, e.g., the complete composition minus at least one compound.

As used herein, the term “about” or “approximately” means within an acceptable error range for the particular value as determined by one of ordinary skill in the art, which will depend in part on how the value is measured or determined, i.e., the limitations of the measurement system, and the degree of precision required for a particular purpose, such as an insect repellent formulation. For example, “about” can mean within 1 or more than 1 standard deviations, per the practice in the art. Alternatively, “about” can mean a range of up to 20%, preferably up to 10%, more preferably up to 5%, and more preferably still up to 1% of a given value.

As used herein, the term “substantially,” means at least 70%, preferably at least 80%, more preferably at least 90%, and even more preferably at least 99%, such as, for example, at least 99.9%. In some embodiments, the term “substantially”can mean completely, or 100%.

As used herein, a “plant essential oil” refers to all plant extractives and their physically modified derivatives such as tinctures, concretes, absolutes, essential oils, oleoresins, terpenes, terpene-free fractions, distillates, steam distillates, residues, enfleurage pomades, etc., that contain one or more volatile components, and may be derived from flowers, buds, leaves, bark, sapwood, heartwood, roots, roots, resin, peels, or other plant component, or combinations of more than one of these components.

Plant essential oils may include, for example, agar oil, ajwain oil, almond extract, angelica root oil, anise oil, asafetida oil (from Ferula sp.), balsam of Peru (Myroxylon spp.), basil oil (Ocimum spp.), bay leaf oil (Laurus nobilis), bergamot oil, black pepper oil, birch oil (Betula spp.), Cannabis spp. oil, carrot oil, carrot seed oil, oils and extracts from Cinnamomum spp. (including camphor oil, cinnamon oil, cinnamon extract, cassia oil, Saigon cinnamon oil, Indian bay leaf oil, and Ceylon cinnamon oil), Citrus spp. oils (including neroli, petitgrain, calamondin oil, bergamot oil, mandarin oil, tangerine oil, citron oil, lime oil, orange oil, orange extract, grapefruit oil, and lemon oil, lemon extract), caraway seed oil, cedar oil (or cedarwood oil, from conifer families Cupressaceae and/or Pinaceae, including Virginia cedarwood oil, Texas cedarwood oil, Atlas cedar oil, and Himalayan cedar oil,), chamomile oil, calamus oil, cleary sage oil, coconut oil, clove oil, clove extract, coffee oil, coriander oil, costmary oil (Tanacetum balsamita), Costus spp. oil, cubeb oil, cumin seed oil, black cumin oil (Nigella sativa, black seed oil), cypress oil (Fokienia spp., fokenia oil), Cyperus scariosus oil (cypriol oil), curry leaf oil, davana oil, elemi oil, eucalyptus oil (from Eucalyptus spp.), fennel seed oil, fenugreek oil, frankincense oil, galangal oil, galbanum oil, garlic oil, geranium oil (Pelargonium spp., especially P. graveolens), ginger oil, ginger extract, guaiacwood oil, hyssop oil, jasmine oil, juniper berry oil (Juniperus sp.), lavender oil (Lavandula spp.), Ledum spp. oil, lemongrass oil (Cymbopogon spp.), oil of lemon eucalyptus, Litsea cubeba oil, marjoram oil, Melissa oil (lemon balm oil, Melissa officinalis), Mentha spp. oils and extracts (including peppermint oil, peppermint extract, spearmint oil, spearmint extract, watermint oil, corn mint oil, pennyroyal oil, apple mint oil, and oils from Mentha hybrids), mustard oil, myrrh oil, neem oil (neem tree oil), Nepeta spp. oils, nutmeg oil, oregano oil, orris oil, parsley oil, parsley seed oil, patchouli oil, perilla oil, pine oil (Pinus spp.), rose oil, rosehip oil, rose extract, rosemary oil, rosewood oil, sage oil, sandalwood oil (Sandalus spp.), sassafras oil, savory oil (Satureja spp.), spruce oil (Picea spp.), star anise oil, tarragon oil, tea tree oil, thyme oil, vanilla extract, valerian oil, vetiver oil, violet extract, wintergreen oil (oil of wintergreen), wintergreen extract, yarrow oil, and ylang-ylang oil.

Geraniol is a monoterpenoid and an alcohol. It is the primary part of oil-of-rose and palmarosa oil. It is used in perfumes and as a flavoring. It is also produced by the scent glands of honeybees to help them mark nectar-bearing flowers and locate the entrances to their hives. In certain non-limiting embodiments, where geraniol is employed, it may be mixed with 10%, 20%, 30%, or 40% or more nerol. Commercially obtained geraniol may be designated by the amount of geraniol it contains. For example, a 60/40 mixture of geraniol and nerol is termed “geraniol 60.” Nerol is a monoterpene (C₁₀H₁₈O), the Z-isomer of geraniol, which can be extracted from attar of roses, oil of orange blossoms and oil of lavender. Citral (3,7-dimethyl-2,6-octadienal or lemonal) is the generic name for the aldehyde form of nerol and geraniol, and can be obtained from lemon myrtle, Litsea cubeba, lemongrass, Lemon verbena, lemon balm, lemon, and orange. The E-isomer of citral is known as geranial or citral A. The Z-isomer is known as neral or citral B. Where an embodiment describes the use of any form of geraniol, other embodiments are specifically contemplated in which the geraniol is replaced by another form of geraniol (such as Geraniol Fine FCC or any geraniol/nerol mixture), nerol, geranial, neral, citral, or a mixture of any of these with each other or with any form of geraniol. Similarly, where an embodiment describes the use of any form of citral, other embodiments are specifically contemplated in which the citral is replaced by a form of geraniol (such as Geraniol Fine FCC or any geraniol/nerol mixture), nerol, geranial, neral, or a mixture of any of these with each other or with citral.

Vanillin (also known as methyl vanillin, vanillic aldehyde, vanillin, and 4-hydroxy-3-methoxybenzaldehyde) is the primary component of the extract of the vanilla bean. In addition to vanillin, natural vanilla extract also contains p-hydroxybenzaldehyde, vanillic acid, piperonal, and p-hydroxybenzoic acid. Synthetic vanillin is used as a flavoring agent in foods, beverages, and pharmaceuticals. Where an embodiment describes the use of vanillin, other embodiments are specifically contemplated in which the vanillin is replaced by natural vanilla extract, p-hydroxybenzaldehyde, vanillic acid, piperonal, ethyl vanillin, or p-hydroxybenzoic acid, or a mixture of any of these with each other or with vanillin.

As used herein, “water-soluble organic cosolvents” refer to organic solvents that are soluble at a level greater than 1% by volume in water at 20° C., or preferably, greater than 5% by volume in water, including those that are fully miscible. Suitable water-soluble organic solvents include, for example, the alcohols methanol, ethanol, 1-propanol, 2-propanol (isopropyl alcohol), 1-butanol, 2-butanol, isobutanol, tert-butanol, benzyl alcohol, ethylene glycol, 1,2-propanediol (propylene glycol), 1,3-propanediol, 1,2-butanediol, 1,3-butanediol, 1,4-butanediol, 2,3-butanediol, 1,2-pentanediol (pentylene glycol), 1,5-pentanediol, 2-methyl-2,4-pentanediol (hexylene glycol), and glycerin (propane-1,2,3-triol); the glycol ether solvents including 2-methoxyethanol (ethylene glycol methyl ether), 2-ethoxyethanol (ethylene glycol ethyl ether, cellosolve), 2-propoxyethanol (ethylene glycol propyl ether), 2-isopropoxyethanol (ethylene glycol isopropyl ether), 2-butoxyethanol (ethylene glycol butyl ether), 2-phenoxyethanol (ethylene glycol monophenyl ether), 1-methoxy-2-propanol (propylene glycol methyl ether), diethylene glycol, 2-(2-methoxyethoxy)ethanol (diethylene glycol monomethyl ether, methyl carbitol), 2-(2-ethoxyethoxy)ethanol (diethylene glycol monoethyl ether, ethyl carbitol), dipropylene glycol, dipropylene glycol monomethyl ether, 1,2-dimethoxyethane (glyme), 1,2-diethoxyethane, 1-methoxy-2-(2-methoxyethoxy)ethane (diglyme), 1-ethoxy-2-(2-ethoxyethoxy)ethane (diethylene glycol diethyl ether), 1,2-bis(2-methoxyethoxy)ethane (triethylene glycol dimethyl ether, triglyme), and 1-methoxy-2-[2-[2-(2-methoxyethoxy)ethoxy]ethoxy]ethane (tetraglyme, tetraethylene glycol dimethyl ether); the organic carbonate esters, including dimethyl carbonate, diethyl carbonate, diphenyl carbonate, ethylene carbonate, propylene carbonate, trimethylene carbonate; and carboxylate esters, including methyl acetate, ethyl formate, ethyl acetate, methyl lactate, ethyl lactate, propyl lactate, isopropyl lactate, butyl lactate, (+)-methyl lactate, (+)-ethyl lactate, (+)-propyl lactate, (+)-isopropyl lactate, and (+)-butyl lactate; also included are acetone, 2-butanone, acetonitrile, sulfolane, dimethyl sulfoxide, N, N-dimethylformamide, N,N-dimethylacetamide, nitromethane, methyl acetate, ethyl formate, ethyl acetate, formic acid, acetic acid, and tetrahydrofuran. “Water-soluble organic cosolvents” may refer to a single suitable solvent, or a combination thereof.

In certain non-limiting embodiments, the insect repellent composition disclosed herein includes isopropanol. Isopropanol is used because of its solubility, volatility, evaporation potential leaving no residue, safety, inexpense, and its infinite miscibility with water.

In certain non-limiting embodiments, surfactants can be used that are high purity, readily sourced, consistent quality, compatible across a wide pH range, compatible in a range of ionic strengths when in aqueous solution, compatible with isopropanol and/or water, and able to properly disperse oils for stable emulsion.

As used herein, the term “surfactant” refers specifically to ionic surfactants, including, for example, the organosulfates, such as sodium dodecyl sulfate (sodium lauryl sulfate, SDS, SLS), potassium dodecyl sulfate, ammonium dodecyl sulfate, sodium decyl sulfate, sodium octyl sulfate, sodium laureth sulfate, sodium myreth sulfate, sodium pareth sulfonate; the organosulfonates, including one or more of the isomeric linear or branched sodium dodecylbenzenesulfonates, sodium decylbenzensulfonates, sodium octylbenzenesulfonates, and sodium bis(2-ethylhexyl) sulfosuccinate (docusate sodium); the isethionates, including sodium butyl isethionate, sodium capryloyl isethionate, sodium caproyl isethionate, sodium lauroyl isethionate, and sodium palmitoyl isethionate; and the suitable sodium, potassium, ammonium, or amine salts of a fatty acid; or a combination thereof.

As used herein, the term “acylglycerol-derived emulsifiers” refers to nonionic surfactants, detergents, wetting agents, emulsifiers, foaming agents, or dispersants chemically derived from the esterification of least one glycerol unit and at least one fatty acid, such that at least one glycerol hydroxyl group is not esterified. As used herein, the term “polyglycerol fatty acid monoester” refers to acylglycerol-derived emulsifiers with more than one glycerol unit and exactly one fatty acid ester. As used herein, the term “polyglycerol fatty acid multi-ester” refers to acylglycerol-derived emulsifiers with more than one glycerol unit and more than one fatty acid ester. Suitable acylglycerol-derived emulsifiers include, for example, glycerol monolaurate (monolaurin, 2,3-dihydroxypropyl dodecanoate), glycerol dilaurate (dilaurin), glycerol monodecanoate (monocaprin, monodecanoyl glycerol, 2,3-dihydroxypropyl decanoate), monomyristin (monotetradecanoyl glycerol, 2,3-dihydroxypropyl tetradecanoate), monopalmitin (monohexadecanoyl glycerol, 2,3-dihydroxypropyl hexadecanoate), polyglycerol octanoate, polyglycerol decanoate, polyglycerol dodecanoate (polyglycerol laurate), polyglycerol tetradecanoate (polyglycerol myristate), polyglycerol hexadecanoate (polyglycerol palmitate), polyglycerol octadecanoate (polyglycerol stearate), polyglycerol oleate, polyglyceryl-2 caprate, polyglyceryl-2 caprylate, polyglyceryl-2 laurate, polyglyceryl-2 myristate, polyglyceryl-2 isopalmitate, polyglyceryl-2 palmitate, polyglyceryl-2 isostearate, polyglyceryl-2 oleate, polyglyceryl-2 stearate, polyglyceryl-3 caprate, polyglyceryl-3 caprylate, polyglyceryl-3 laurate, polyglyceryl-3 myristate, polyglyceryl-3 palmitate, polyglyceryl-3 isostearate, polyglyceryl-3 oleate, polyglyceryl-3 stearate, polyglyceryl-3 ricinoleate, polyglyceryl-4 caprate, polyglyceryl-4 caprylate, polyglyceryl-4 laurate, polyglyceryl-4 isostearate, polyglyceryl-4 oleate, polyglyceryl-4 stearate, polyglyceryl-5 caprate, polyglyceryl-5 laurate, polyglyceryl-5 myristate, polyglyceryl-5 isostearate, polyglyceryl-5 oleate, polyglyceryl-5 stearate, polyglyceryl-5 ricinoleate, polyglyceryl-6 caprate, polyglyceryl-6 caprylate, polyglyceryl-6 undecylenate, polyglyceryl-6 laurate, polyglyceryl-6 myristate, polyglyceryl-6 palmitate, polyglyceryl-6 isostearate, polyglyceryl-6 oleate, polyglyceryl-6 stearate, polyglyceryl-6 ricinoleate, polyglyceryl-8 oleate, polyglyceryl-8 stearate, polyglyceryl-10 caprate, polyglyceryl-10 caprylate, polyglyceryl-10 undecylenate, polyglyceryl-10 laurate, polyglyceryl-10 myristate, polyglyceryl-10 palmitate, polyglyceryl-10 isostearate, polyglyceryl-10 linoleate, polyglyceryl-10 oleate, polyglyceryl-10 stearate, polyglyceryl-4 dilaurate, polyglyceryl-4 pentaoleate, polyglyceryl-4 distearate, polyglyceryl-4 tristearate, polyglyceryl-4 pentastearate, polyglyceryl-5 dicaprylate, polyglyceryl-5 dilaurate, polyglyceryl-5 trimyristate, polyglyceryl-5 pentamyristate, polyglyceryl-5 triisostearate, polyglyceryl-5 dioleate, polyglyceryl-5 trioleate, polyglyceryl-5 tristearate, polyglyceryl-5 hexastearate, polyglyceryl-6 sesquicaprylate, polyglyceryl-6 dicaprate, polyglyceryl-6 tricaprylate, polyglyceryl-6 tetracaprylate, polyglyceryl-6 pentacaprylate, polyglyceryl-6 heptacaprylate, polyglyceryl-6 octacaprylate, polyglyceryl-6 dipalmitate, polyglyceryl-6 sesquiisostearate, polyglyceryl-6 diisostearate, polyglyceryl-6 dioleate, polyglyceryl-6 tetraoleate, polyglyceryl-6 pentaoleate, polyglyceryl-6 hexaoleate, polyglyceryl-6 sesquistearate, polyglyceryl-6 distearate, polyglyceryl-6 tristearate, polyglyceryl-6 pentastearate, polyglyceryl-6 hexastearate, polyglyceryl-6 octastearate, polyglyceryl-6 pentaricinoleate, polyglyceryl-6 tetrabehenate, and combinations thereof.

In some embodiments, the adjustment of the pH of the formulations may be desirable, for example, for reasons of formulation kinetic stability, formulation stability, thermal stability, and microbial growth inhibition. The pH of the formulation may be lowered through the addition of a suitable acid or buffer, including, for example, hydrochloric acid, sulfuric acid, phosphoric acid, sodium dihydrogenphosphate, potassium dihydrogen phosphate, acetic acid, vinegar, propionic acid, citric acid, monosodium citrate, monopotassium citrate, calcium citrate, ammonium citrate, ammonium ferric citrate, benzoic acid, formic acid, succinic acid, malic acid, sodium malate, potassium malate, calcium malate, magnesium malate, fumaric acid, sodium fumarate, potassium fumarate, calcium fumarate, magnesium fumarate, maleic acid, lactic acid, sodium lactate, potassium lactate, calcium lactate, magnesium lactate, tartaric acid, sodium tartrate, potassium tartrate, calcium tartrate, magnesium tartrate, adipic acid, sodium adipate, potassium adipate, ascorbic acid (vitamin C), carbon dioxide, carbonic acid, and glyoxylic acid, and combinations thereof. The pH of the formulation may be raised through the addition of a suitable base of buffer, including, for example, sodium carbonate, potassium carbonate, sodium bicarbonate, ammonium carbonate, ammonium acetate, sodium acetate, potassium acetate, calcium acetate, magnesium acetate, sodium citrate, trisodium citrate, monopotassium citrate, tripotassium citrate, calcium citrate, ammonium citrate, triammonium citrate, ammonium ferric citrate, sodium benzoate, potassium benzoate, ammonium benzoate, sodium malate, potassium malate, calcium malate, magnesium malate, sodium fumarate, potassium fumarate, calcium fumarate, magnesium fumarate, sodium lactate, potassium lactate, calcium lactate, magnesium lactate, tartrate, potassium tartrate, sodium potassium tartrate, calcium tartrate, magnesium tartrate, sodium adipate, potassium adipate, sodium ascorbate, sodium hydroxide, and potassium hydroxide, disodium hydrogenphosphate, dipotassium hydrogenphosphate, trisodium phosphate, tripotassium phosphate, sodium borate, and mixtures thereof.

In some non-limiting embodiments, the addition of a preservative may be desirable to prevent microbial growth. Suitable preservatives include, for example, benzoic acid, ammonium benzoate, sodium benzoate, potassium benzoate, calcium benzoate, magnesium benzoate, salts of benzoic acid, ammonium acetate, boric acid, sodium borate, borax, sodium bisulfite, potassium bisulfite, magnesium bisulfite, calcium bisulfite, sodium sulfite, potassium sulfite, magnesium sulfite, calcium sulfite, sodium metabisulfite, potassium metabisulfite, sodium nitrate, potassium nitrate, sodium nitrite, potassium nitrite, ethylenediaminetetraacetic acid (EDTA), disodium EDTA, calcium disodium EDTA, tetrasodium EDTA, salts of EDTA, calcium formate, sorbic acid, sodium sorbate, potassium sorbate, calcium sorbate, magnesium sorbate, salts of sorbic acid, dimethyl carbonate, methyl paraben, ethyl paraben, propyl paraben, butyl paraben, isobutyl paraben, heptyl parapen, parabens, sodium methyl paraben, sodium ethyl paraben, sodium salts of parabens, potassium salts of parabens, formaldehyde, formic acid, sodium formate, potassium formate, calcium formate, magnesium formate, salts of formic acid, hexamine, acetic acid, sodium acetate, potassium acetate, calcium acetate, magnesium acetate, salts of acetic acid, and sulfur dioxide, chlorhexidine, polyhexidine, polyaminopropyl biguanidine, benzalkonium chloride, stearalkonium chloride, cetalkonium chloride, Quaternium-15, quarternary ammonium salts, triclosan, thiomersal, 2-methyl-4-isothiazolin-3-one, 5-chloro-2-methyl-4-isothiazolin-3-one, benzisothiazolinone, 1,3-bis(hydroxymethyl)-5,5-dimethylimidazolidine-2,4-dione (DMDM hydantoin), diazolidinyl urea, imidazolidinyl urea, thiabendazole (tiabendazole), and combinations thereof.

In certain non-limiting embodiments, cellulose film forming agents can be used that are high purity, readily sourced, consistent quality, clear upon drying, soluble in isopropanol and/or water, compatible with various surfactants and other formulation moieties, and a molecular weight to facilitate stability and dilutability.

As used herein, the term “viscosity modifier” refers to compounds, polymers, or additives that increase or decrease the viscosity of the microemulsion. In some embodiments, the inclusion of a viscosity modifier to adjust viscosity may be desirable. Viscosity modifiers may be used, for example, to increase the kinetic stability of a formulation and/or to improve the aesthetics, wetting properties, and/or film-forming properties of the formulation. In some embodiments, an acylglycerol-derived emulsifier also acts as a viscosity modifier. In some embodiments, a non-acylglycerol-derived emulsifier also acts as a viscosity modifier.

Many additives can serve as viscosity modifiers and/or non-acylglycerol-derived emulsifiers. Compounds suitable for use as non-acylglycerol-derived emulsifiers and/or viscosity modifiers include, for example, the polysorbates, including polysorbate 20, polysorbate 40, polysorbate 60, and polysorbate 80; sorbitan esters including sorbitan monolaurate, sorbitan monosterate, and sorbitan tristate; lecithins; oligomers, polymers, copolymers, block copolymers, and cross polymers of polyethylene glycol, polypropylene glycol, polyvinylpyrrolidone, polyacrylates, poloxamers (triblock copolymers of the form poly(ethylene oxide)-block-poly(propylene oxide)-block-poly(ethylene oxide)); PEGylated fatty acids, acylglycerols, fatty alcohols, and waxes, including PEG-8 beeswax, PEG-7 glyceryl cocoate, PEG-8 cocoate, PEG-8 glyceryl isosterate, PEG-8 isosterate, PEG-8 distearate, PEG-8 laurate (octaethylene glycol monododecyl ether), PEG-5 laurate (pentaethylene glycol monododecyl ether), PEG-40 hydrogenated castor oil, PEG-80 glyceryl stearate, PEG-150 distearate, ceteareth-20 (ethoxylated C16-18 alcohols, with 20:1 ethylene oxide: fatty alcohol average ratio), ceteareth-25 (ethoxylated C16-18 alcohols, with 25:1 ethylene oxide: fatty alcohol average ratio), isoceteth-20 (polyethylene glycol isocetyl ether; ethoxylated cetyl alcohol with 20:1 ethylene oxide: cetyl alcohol average ratio), and triethylene glycol monolauryl ether (Laureth-3); ethylene glycol; propylene glycol; glycerol; fatty alcohols; fatty acids; esters produced by the esterification of a fatty acids with a fatty alcohol, including cetyl palmitate, triacontyl palmitate, and behenyl behenate; beeswax; carnauba wax; natural or modified mono-, oligo, and polysaccharides including agar, alginic acid, sodium alginate, calcium alginate, β-glucans, arrowroot, carob gum, carrageenan, cassia gum, chitosan, cellulose, cellulose acetate, cellulose carboxymethyl ether and its anionic salts, maltodextrin, pyrodextrins, dextrins, galactomannans, gellan gum, glucomannans, guar gum, gum arabic, gum tragacanth, locust bean gum, xanthan gum, pectin, polydextrose, potato starch, hydroxyethyl cellulose, hydroxypropyl cellulose, hydroxypropyl methyl cellulose, methylcellulose, sorbitol, hydrolyzed starch; chondrin; collagen; gelatins; fatty acid amides, including cocoamide DEA (cocoamide diethanolamine), cocoamide MEA (cocoamide monoethanolamine), cocoamidopropyl betaine, lauramide diethanolamine, lauramide monoethanolamine, aryl alkyl polyoxyethylene glycols, lauryl glucoside, nonoynols, nonoxynol-9, octoxynols, and octoxynol-9 (Triton X-100), and combinations thereof.

Triethyl citrate (also known as citric acid, triethyl ester; TEC; ethyl citrate; 2-hydroxy-1,2,3-propanetricarboxylic acid, triethyl ester; and Citroflex 2) is used as a high boiling solvent and plasticizer for vinyl resins and cellulose acetates. It is a plasticizer permitted in the field of food additives, food contact materials, medicines, and pharmaceuticals. Where an embodiment describes the use of triethyl citrate, other embodiments are specifically contemplated in which triethyl citrate may be replaced by other citrate plasticizer esters such as tributyl citrate, acetyl tributyl citrate and tri-(2-ethylhexyl)-citrate, or a mixture of any of these with each other or with triethyl citrate.

Isopropyl myristate is the ester of isopropanol and myristic acid; it is also known as 1-tetradecanoic acid, methylethyl ester; myristic acid isopropyl ester; and propan-2-yl tetradecanoate. Where an embodiment describes the use of isopropyl myristate, other embodiments are specifically contemplated in which isopropyl myristate may be replaced by similar chemicals such as isopropyl palmitate, isopropyl stearate, isostearyl neopentonate, myristyl myristate, decyl oleate, octyl sterate, octyl palmitate, isocetyl stearate, or PPG myristyl propionate, or a mixture of any of these with each other or with isopropyl myristate. Isopropyl myristate may also be used as a thickening agent and emollient.

In certain non-limiting embodiments of the present invention, “synergy” can refer to any substantial enhancement, in a combination of at least two ingredients, of a measurable effect, when compared with the effect of one active ingredient alone, or when compared with the effect of the complete combination minus at least one ingredient. Synergy is a specific feature of a combination of ingredients and is above any background level of enhancement that would be due solely to, e.g., additive effects of any random combination of ingredients. Effects include but are not limited to repellent effect of the composition; pesticidal effect of the composition; perturbation of a cell message or cell signal such as, e.g., calcium, cyclic-AMP, and the like; and diminution of activity or downstream effects of a molecular target.

As used herein, “synergy” and “synergistic effect” can refer to any substantial enhancement, in a composition of at least two compounds, of a measurable effect, e.g., an antiparasitic, pesticidal, or herbicidal effect, when compared with the effect of a component of the composition, e.g., one active compound alone, or the complete blend of compounds minus at least one com pound. Synergy is a specific feature of a blend of compounds and is above any background level of enhancement that would be due solely to, e.g., additive effects of any random combination of ingredients.

As used herein, “active component or active ingredients” shall refer to the one or more substances that, together or separately, provide a desired function. Active components may include water-soluble or oil-soluble pesticidal compounds or substances, pharmaceutical compounds, cosmetics, nutraceuticals, cleaning agents, dyes, pigments, lubricants, fertilizers, coatings, waxes, plant essential oils, synergists, wetting agents, spreading agents, antifoaming agents, fragrances, terpenes, flavorings, and combinations thereof. The active components or active ingredients have high purity, readily sourced, consistent quality, and are preferably selected from the EPA's minimum risk pesticides “25b” active ingredients list.

Certain non-limiting embodiments of the invention can include, for example, one or more ingredients on the 25(b) list of active ingredients that can be used in pesticide products that are exempt from the Federal Insecticide, Fungicide, and Rodenticide Act (FIFRA) under the Minimum Risk Exemption regulations in 40 CFR 152.25(f), the entire text whereof is incorporated by reference into the present application. In some embodiments, those ingredients can include, for example, castor oil, cedarwood oil, cinnamon, cinnamon oil, citric acid, citronella, citronella oil, cloves, clove oil, corn gluten meal, corn oil, cornmint, cornmint oil, cottonseed oil, dried blood, eugenol, garlic, garlic oil, geraniol, geranium oil, lauryl sulfate, lemongrass oil, linseed oil, malic acid, peppermint, peppermint oil, 2-phenylethyl propionate, potassium sorbate, putrescent whole egg solids, rosemary, rosemary oil, sesame, sesame oil, sodium chloride, sodium lauryl sulfate, soybean oil, spearmint, spearmint oil, thyme, thyme oil, white pepper, and zinc.

Certain non-limiting embodiments of the invention can include, for example, one or more ingredients on the 4(a) list of inert ingredients that can be used in pesticide products that are exempt from the Federal Insecticide, Fungicide, and Rodenticide Act (FIFRA) under the Minimum Risk Exemption regulations in 40 CFR 152.25(f), the entire text whereof is incorporated by reference into the present application. In some embodiments, those ingredients can include, for example, acetyl tributyl citrate, agar, almond oil, alpha-cyclodextrin, aluminatesilicate, aluminum magnesium silicate, aluminum potassium sodium silicate, aluminum silicate, aluminum sodium silicate, ammonium benzoate, ammonium stearate, amylopectin acid-hydrolyzed 1-octenylbutanedioate, amylopectin hydrogen 1-octadecenylbutanedioate, ascorbyl palmitate, attapulgite-type clay, beeswax, bentonite, bentonite sodium, beta-cyclodextrin, (+)-butyl lactate, butyl lactate, butyl stearate, calcareous shale, calcite, calcium acetate, calcium acetate monohydrate, calcium benzoate, calcium carbonate, calcium citrate, calcium octanoate, calcium oxide silicate, calcium silicate, calcium stearate, calcium sulfate, calcium sulfate, dihydrate, calcium sulfate hemihydrate, canary seed, carbon, carbon dioxide, carboxymethyl cellulose, carnauba wax, carob gum, carrageenan, caseins, castor oil, castor oil hydrogenated, cellulose, cellulose acetate, cellulose mixture with cellulose carboxymethyl ether sodium salt, cellulose pulp, cellulose regenerated, citric acid, citric acid monohydrate, corn cobs, cotton, decanoic acid monoester with 1,2,3-propanetriol, dextrins, diglyceryl monooleate, diglyceryl monostearate, dilaurin, dipalmitin, dipotassium citrate, disodium citrate, disodium sulfate, dodecanoic acid monoester with 1,2,3-propanetriol, (+)-ethyl lactate, gamma-cyclodextrin, glycerin, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, glyceryl stearate, humic acid, hydroxyethyl cellulose, hydroxylpropyl cellulose, hydroxypropyl methyl cellulose, isopropyl alcohol, isopropyl myristate, lauric acid, lecithins, linseed oil, magnesium carbonate, magnesium benzoate, magnesium oxide, magnesium oxide silicate, magnesium silicate, magnesium silicate hydrate, magnesium silicon, magnesium stearate, magnesium sulfate, magnesium sulfate heptahydrate, malic acid, maltodextrin, methylcellulose, mineral oil, 1-monolaurin, 1-monomyristin, monomyristin, monopalmitin, monopotassium citrate, monosodium citrate, myristic acid, nitrogen, octanoic acid potassium salt, octanoic acid sodium salt, oleic acid, palm oil, palmitic acid, paraffin wax, pectin, perlite, polyethylene, polyglyceryl oleate, polyglyceryl stearate, potassium acetate, potassium aluminum silicate, potassium benzoate, potassium bicarbonate, potassium chloride, potassium citrate, potassium humate, potassium myristate, potassium oleate, potassium ricinoleate, potassium sorbate, potassium stearate, potassium sulfate, 1,2-propylene carbonate, silica, silicic acid magnesium salt, soap, sodium acetate, sodium alginate, sodium benzoate, sodium bicarbonate, sodium carboxymethyl cellulose, sodium chloride, sodium citrate, sodium humate, sodium humatte, sodium oleate, sodium ricinoleate, sodium stearate, sodium sulfate, sorbitol, soya lecithins, stearic acid, sulfur, tetraglyceryl monooleate, tricalcium citrate, triethyl citrate, tripotassium citrate, trisodium citrate, urea, vanillin, vermiculite, vinegar, vitamin C, vitamin E, white mineral oil, wintergreen oil, xanthan gum, zeolites, zinc iron oxide, zinc oxide, and zinc stearate.

Embodiments of the insect repellent compositions disclosed herein comprise active ingredients (AI), surfactants, film-forming agents, stabilizers, application enhancers, rheology modifiers, encapsulating additives, and solvents. The ingredients are deemed minimum risk pesticides by the EPA and are eligible for FIFRA-exempt (i.e., no federal EPA registration required) pesticide products ensuring safety and environmental compliance.

In certain non-limiting embodiments, the insect repellent compositions herein are concentrates, which are diluted with water prior to application. Beneficial features of the insect repellent compositions disclosed herein include the ability to repel common urban pests, including ants and cockroaches. The insect repellent compositions are able to repel pests by forming a substantially clear, colorless, robust film that secures the AI(s) in place and prolongs/delays release. The insect repellent compositions are non-damaging to household items and leave no tacky residue. The concentrates are stable and of relatively low viscosity. The diluted concentrates remain stable and homogenous in water for over 24 hours and are suitable for application with most common spray equipment.

The ingredients and their functions are crucial to embodiments of the insect repellent compositions disclosed herein. For example, film-forming polymers such as HPC (Hydroxypropyl Cellulose), Chitosan, and HPMC (Hydroxypropyl Methylcellulose) can be used. HPC is soluble in isopropyl alcohol, forming a hard, clear film and is also water-soluble. Chitosan is used for microencapsulation of AI and film enhancement, while HPMC creates a clear, hard film that can be cleaned with water. Plasticizing solvents, such as isopropyl myristate and triethyl citrate, prevent film cracking, aid in ingredient distribution, and inhibit recrystallization upon drying. Surfactants, such as glyceryl monolaurate (i.e., monolaurin) and mono-and di-glycerides of fatty acids ensure formulation stability, homogenous dilution into water, and stability in various pH environments. The active ingredients (e.g., vanillin, geraniol, and cornmint oil) provide effective insect repellency.

Various embodiments of the insect repellent compositions according to the present disclosure require the following moieties to function properly over the claimed time period of 90 days: (1) active ingredient(s); (2) cellulose film-forming agent(s); and (3) solvent(s).

In certain non-limiting embodiments, surfactants can be included in the insect repellent compositions herein, in order to adequately disperse the active ingredients, cellulose film-forming agents, and solvents into the application phase (typically water).

In certain non-limiting embodiments, stabilizers may be included in the insect repellent compositions herein to obtain an acceptable level of stability within the concentrated formulation and in the diluted solution.

In certain non-limiting embodiments, solvents can used to provide the optimal concentration of all ingredients such that concentrate stability and diluted performance are maximized. In certain non-limiting embodiments, surfactants, additional or different film-forming agents, encapsulation agents, stabilizers, ionic strength modifiers, application enhancers, and solvents can be added.

In certain non-limiting embodiments, an insect repellent composition according to the present disclosure comprises cornmint oil, geraniol, vanillin, monolaurin, isopropyl myristate, triethyl citrate, hydroxypropyl cellulose, citric acid, and isopropanol.

In certain non-limiting embodiments, an insect repellent composition according to the present disclosure comprises cornmint oil, monolaurin, isopropyl myristate, triethyl citrate, hydroxypropyl cellulose, citric acid, and isopropanol.

In certain non-limiting embodiments, an insect repellent composition according to the present disclosure comprises geraniol, monolaurin, isopropyl myristate, triethyl citrate, hydroxypropyl cellulose, citric acid, and isopropanol.

In certain non-limiting embodiments, an insect repellent composition according to the present disclosure comprises vanillin, monolaurin, isopropyl myristate, triethyl citrate, hydroxypropyl cellulose, citric acid, and isopropanol.

In certain non-limiting embodiments, an insect repellent composition according to the present disclosure comprises cornmint oil, geraniol, vanillin, monolaurin, isopropyl myristate, triethyl citrate, hydroxypropyl cellulose, and isopropanol.

In certain non-limiting embodiments, an insect repellent composition according to the present disclosure comprises cornmint oil, monolaurin, isopropyl myristate, triethyl citrate, hydroxypropyl cellulose, and isopropanol.

In certain non-limiting embodiments, an insect repellent composition according to the present disclosure comprises geraniol, monolaurin, isopropyl myristate, triethyl citrate, hydroxypropyl cellulose, and isopropanol.

In certain non-limiting embodiments, an insect repellent composition according to the present disclosure comprises vanillin, monolaurin, isopropyl myristate, triethyl citrate, hydroxypropyl cellulose, and isopropanol.

In certain non-limiting embodiments according to the present disclosure, an insect repellent composition comprises, by weight, 0.1 to 0.5%, 0.1 to 0.45%, 0.1 to 0.4%, 0.1 to 0.35%, 0.1 to 0.3%, 0.15 to 0.5%, 0.15 to 0.45%, 0.15 to 0.4%, 0.15 to 0.35%, 0.15 to 0.3%, 0.2 to 0.5%, 0.2 to 0.45%, 0.2 to 0.4%, 0.2 to 0.35%, 0.2 to 0.3%, 0.05 to 0.40%, 0.05 to 0.35%, 0.05 to 0.3%, or about 0.25% cornmint oil.

In certain non-limiting embodiments according to the present disclosure, an insect repellent composition comprises, by weight, 0.01 to 0.30%, 0.01 to 0.25%, 0.01 to 0.2%, 0.01 to 0.15%, 0.025 to 0.30%, 0.025 to 0.25%, 0.025 to 0.2%, 0.025 to 0.15%, 0.05 to 0.30%, 0.05 to 0.25%, 0.05 to 0.2%, 0.05 to 0.15%, 0.075 to 0.30%, 0.075 to 0.25%, 0.075 to 0.2%, 0.075 to 0.15%, 0.075 to 0.125%, or about 0.1% geraniol.

In certain non-limiting embodiments according to the present disclosure, an insect repellent composition comprises, by weight, 4.0 to 7.0%, 4.5 to 7.0%, 5.0 to 7.0%, 4.0 to 6.5%, 4.5 to 6.5%, 5.0 to 6.5%, 4.0 to 6.0%, 4.5 to 6.0%, 5.0 to 6.0%, 4.0 to 5.5%, 4.5 to 5.5%, or about 5.25% vanillin.

In certain non-limiting embodiments according to the present disclosure, an insect repellent composition comprises, by weight, 0.1 to 0.5%, 0.1 to 0.45%, 0.1 to 0.4%, 0.15 to 0.5%, 0.15 to 0.45%, 0.15 to 0.4%, 0.2 to 0.5%, 0.2 to 0.45%, 0.2 to 0.4%, 0.05 to 0.50%, 0.05 to 0.45%, 0.05 to 0.4%, and about 0.35% isopropyl myristate.

In certain non-limiting embodiments according to the present disclosure, an insect repellent composition comprises, by weight, 0.25 to 1%, 0.35 to 1%, 0.45 to 1%, 0.55 to 1%, 0.25 to 0.85%, 0.35 to 0.85%, 0.45 to 0.85%, 0.55 to 0.85%, 0.25 to 0.75%, 0.35 to 0.75%, 0.45 to 0.75%, 0.55 to 0.75%, 0.25 to 0.65%, 0.35 to 0.65%, 0.45 to 0.65%, or about 0.60% triethyl citrate.

In certain non-limiting embodiments according to the present disclosure, an insect repellent composition comprises, by weight, 0.25 to 1%, 0.35 to 1%, 0.45 to 1%, 0.25 to 0.85%, 0.35 to 0.85%, 0.45 to 0.85%, 0.25 to 0.75%, 0.35 to 0.75%, 0.45 to 0.75%, 0.25 to 0.65%, 0.35 to 0.65%, 0.45 to 0.65%, or about 0.50% monolaurin.

In certain non-limiting embodiments according to the present disclosure, an insect repellent composition comprises, by weight, 2.0 to 6.0%, 2.5 to 6.0%, 3.0 to 6.0%, 3.5 to 6.0%, 4.0 to 6.0%, 2.0 to 5.5%, 2.5% to 5.5%, 3.0 to 5.5%, 3.5 to 5.5%, 4.0 to 5.5%, 2.0 to 5.0%, 2.5 to 5.0%, 3.0 to 5.0%, 3.5 to 5.0%, 4.0 to 5.0%, 2.0 to 4.5%, 2.5 to 4.5%, 3.0 to 4.5%, 3.5 to 4.5%, 4.0 to 4.5%, or about 4.2% hydroxypropyl cellulose.

In certain non-limiting embodiments according to the present disclosure, an insect repellent composition comprises, by weight, 0.01 to 0.30%, 0.01 to 0.25%, 0.01 to 0.2%, 0.01 to 0.15%, 0.025 to 0.30%, 0.025 to 0.25%, 0.025 to 0.2%, 0.025 to 0.15%, 0.05 to 0.30%, 0.05 to 0.25%, 0.05 to 0.2%, 0.05 to 0.15%, 0.075 to 0.30%, 0.075 to 0.25%, 0.075 to 0.2%, 0.075 to 0.15%, 0.075 to 0.125%, or about 0.1% citric acid.

In various embodiments of the insect repellent compositions according to the present dislcosure, the total concentration of solvent, on a by-weight basis as a percentage of the total weight of the formulation, may vary from 5 to 95%, 10 to 90%, 15 to 85%, 20 to 80%, 25 to 75%, 30 to 70%, 35 to 65%, 45.0 to 55%, 75 to 95%, 75 to 96%, 75 to 97%, 75 to 98%, 75 to 99%, 85 to 95%, 85 to 96%, 85 to 97%, 85 to 98%, 85 to 99%, 80 to 95%, 80 to 96%, 80 to 97%, 80 to 98%, 80 to 99%, 85 to 90%, 80 to 90%, or 86 to 89%. For example, certain non-limiting embodiments of an insect repellent composition according to the present disclosure comprise, by weight, 5 to 95%, 10 to 90%, 15 to 85%, 20 to 80%, 25 to 75%, 30 to 70%, 35 to 65%, 45.0 to 55%, 75 to 95%, 75 to 96%, 75 to 97%, 75 to 98%, 75 to 99%, 85 to 95%, 85 to 96%, 85 to 97%, 85 to 98%, 85 to 99%, 80 to 95%, 80 to 96%, 80 to 97%, 80 to 98%, 80 to 99%, 85 to 90%, 80 to 90%, 86 to 89%, or about 88.65% isopropanol.

Various non-limiting aspects according to the present disclosure are provided in the following clauses. It will be understood that the inventions described in the following clauses are exemplary only, and are not necessarily limiting of the invention of the present disclosure.

Clause 1: An insect repellent composition comprising, in weight percentages based on total weight of the composition:
0.1 to 0.5% cornmint oil;
0.05 to 0.5% isopropyl myristate;
0.25 to 1.0% triethyl citrate;
0.25 to 1.0% monolaurin;
2.0 to 6.0% hydroxypropyl cellulose;
0.01 to 0.3% citric acid; and
isopropanol.

Clause 2: An insect repellent composition comprising, in weight percentages based on total weight of the composition:
0.01 to 0.3% geraniol;
0.05 to 0.5% isopropyl myristate;
0.25 to 1.0% triethyl citrate;
0.25 to 1.0% monolaurin;
2.0 to 6.0% hydroxypropyl cellulose;
0.01 to 0.3% citric acid; and
isopropanol.

Clause 3: An insect repellent composition comprising, in weight percentages based on total weight of the composition:
4.0 to 7.0% vanillin;
0.05 to 0.5% isopropyl myristate;
0.25 to 1.0% triethyl citrate;
0.25 to 1.0% monolaurin;
2.0 to 6.0% hydroxypropyl cellulose;
0.01 to 0.3% citric acid; and
isopropanol.

Clause 4: An insect repellent composition comprising, in weight percentages based on total weight of the composition:
0.1 to 0.5% cornmint oil;
0.01 to 0.3% geraniol;
4.0 to 7.0% vanillin;
0.05 to 0.5% isopropyl myristate;
0.25 to 1.0% triethyl citrate;
0.25 to 1.0% monolaurin;
2.0 to 6.0% hydroxypropyl cellulose;
0.01 to 0.3% citric acid; and
isopropanol.

Clause 5: An insect repellent composition comprising, in weight percentages based on total weight of the composition:
0.1 to 0.5% cornmint oil;
0.05 to 0.5% isopropyl myristate;
0.25 to 1.0% triethyl citrate;
0.25 to 1.0% monolaurin;
2.0 to 6.0% hydroxypropyl cellulose; and
isopropanol.

Clause 6: An insect repellent composition comprising, in weight percentages based on total weight of the composition:
0.01 to 0.3% geraniol;
0.05 to 0.5% isopropyl myristate;
0.25 to 1.0% triethyl citrate;
0.25 to 1.0% monolaurin;
2.0 to 6.0% hydroxypropyl cellulose; and
isopropanol.

Clause 7: An insect repellent composition comprising, in weight percentages based on total weight of the composition:
4.0 to 7.0% vanillin;
0.05 to 0.5% isopropyl myristate;
0.25 to 1.0% triethyl citrate;
0.25 to 1.0% monolaurin;
2.0 to 6.0% hydroxypropyl cellulose; and
isopropanol.

Clause 8: An insect repellent composition comprising, in weight percentages based on total weight of the composition:
0.1 to 0.5% cornmint oil;
0.01 to 0.3% geraniol;
4.0 to 7.0% vanillin;
0.05 to 0.5% isopropyl myristate;
0.25 to 1.0% triethyl citrate;
0.25 to 1.0% monolaurin;
2.0 to 6.0% hydroxypropyl cellulose; and
isopropanol.

Clause 9: A method for controlling pests, comprising administering the insect repellent composition of any of clauses 1-8 to an area.

1.-9. (canceled)

10. An insect repellent composition comprising, in weight percentages based on total weight of the composition:
0.05 to 0.5% isopropyl myristate;
0.25 to 1.0% triethyl citrate;
0.25 to 1.0% monolaurin;
2.0 to 6.0% hydroxypropyl cellulose;
isopropanol; and
at least one of 0.1 to 0.5% cornmint oil, 0.01 to 0.3% geraniol, and 4.0 to 7.0% vanillin.

11. The insect repellent composition of claim 10, further comprising, in weight percentages based on total weight of the composition, 0.01 to 0.3% citric acid.

12. The insect repellent composition of claim 10, comprising, in weight percentages based on total weight of the composition:
0.05 to 0.5% isopropyl myristate;
0.25 to 1.0% triethyl citrate;
0.25 to 1.0% monolaurin;
2.0 to 6.0% hydroxypropyl cellulose;
isopropanol; and
0.1 to 0.5% cornmint oil.

13. The insect repellent composition of claim 12, further comprising, in weight percentages based on total weight of the composition, 0.01 to 0.3% citric acid.

14. The insect repellent composition of claim 10, comprising, in weight percentages based on total weight of the composition:
0.05 to 0.5% isopropyl myristate;
0.25 to 1.0% triethyl citrate;
0.25 to 1.0% monolaurin;
2.0 to 6.0% hydroxypropyl cellulose;
isopropanol; and
0.01 to 0.3% geraniol.

15. The insect repellent composition of claim 14, further comprising, in weight percentages based on total weight of the composition, 0.01 to 0.3% citric acid.

16. The insect repellent composition of claim 10, comprising, in weight percentages based on total weight of the composition:
0.05 to 0.5% isopropyl myristate;
0.25 to 1.0% triethyl citrate;
0.25 to 1.0% monolaurin;
2.0 to 6.0% hydroxypropyl cellulose;
isopropanol; and
4.0 to 7.0% vanillin.

17. The insect repellent composition of claim 16, further comprising, in weight percentages based on total weight of the composition, 0.01 to 0.3% citric acid.

18. An insect repellent composition comprising, in weight percentages based on total weight of the composition:
0.1 to 0.5% cornmint oil;
0.01 to 0.3% geraniol;
0.05 to 0.5% isopropyl myristate;
0.25 to 1.0% triethyl citrate;
0.25 to 1.0% monolaurin;
2.0 to 6.0% hydroxypropyl cellulose; and
isopropanol.

19. The insect repellent composition of claim 18, further comprising, in weight percentages based on total weight of the composition, 0.01 to 0.3% citric acid.

20. The insect repellent composition of claim 18, further comprising, in weight percentages based on total weight of the composition, 4.0 to 7.0% vanillin.

21. The insect repellent composition of claim 20, further comprising, in weight percentages based on total weight of the composition, 0.01 to 0.3% citric acid.

22. A method for controlling pests, comprising administering the insect repellent composition of claim 10 to an area.
